(19) United States
(12) Patent Application Publication
(10) Pub. No.: US 2004/0047670 A1
(43) Pub. Date: Mar. 11, 2004

(54) Floor cleaning implement with incorporated floor cleaning liquid

(76) Inventor: Jesus Lasheras Martin, Zaragoza (ES)

Correspondence Address: Jesus Lasheras Martin, Plaza Aragon, 4, 40C, Zaragoza, 50004, ES

(21) Appl. No.: 10/450,426

(22) PCT Filed: Feb. 21, 2001
(86) PCT No.: PCT/ES01/00065

(30) Foreign Application Priority Data
Jan. 24, 2001 (ES) P 200100164

(51) Int. Cl. A47L 13/30; B43M 11/02

(52) U.S. Cl. 401/138; 401/137; 401/270

(57) ABSTRACT

The invention concerns a transparent tube (2) that is filled with a mixture of water and a floor cleaning product. The top part of said tube has a spray gun (1) through which the liquid is sprayed onto the floor. The bottom part of said tube has a base (5) to which a sponge is attached (6). The invention makes it possible to clean all types of floors without having to use a wringer pail. The user can regulate the degree of wetting of the floor. It also makes it possible to clean underneath furniture, beds, etc. The sponge can be detached from the base with the purpose of cleaning said sponge by means of various reusable adherence techniques. In another embodiment, the sponge is glued to a disposable base.

### FIELD OF THE INVENTION

The current invention relates to the field of floor cleaning implements, particularly to a handle with cleaning liquid incorporated having a top spray gun. It is aimed at mopping floors with the highest convenience and speed.

### BACKGROUND OF THE INVENTION

The yellow-cloth-strip mops or the cotton-strips mop, which are used-together with a bucket, provided with a colander to wring out the mop are the most common system to mop floors. There are semiautomatic-wring-out mops but still need a bucket of water and cleaning product.

### TECHNICAL PROBLEM OF THE BACKGROUND OF THE INVENTION

Mopping with a traditional mop involves:

1. The inconvenience of pulling along a full and heavy bucket

2. The physical effort of wringing out the mop.

3. The possibility that the bucket falls over and the water spills over the floor.

4. The loss of time when we rinse and wring the mop out.

5. The inconvenience and loss of time when we change the water.

6. The limitation of certain floors (for instance: wooden floors just allow a very good wringing)

7. The water gets dirty after rinsing the mop from the first wipe and consequently that dirt in the water is spread all over the floor.

8. The difficulty in cleaning the strips of the mop head

9. The high consumption of water and cleaning product.

Solution and Advantages of the Invention

Mopping with the present invention involves:

1. The elimination of the bucket

2. No more physical effort wringing the mop out.

3. The impossibility of the water spilling or bucket falling.

4. The important saving of time having to rinse the sponge.

5. The saving of time not having to change water from the bucket any more.

6. The possibility of mopping all kind of floor, including those that need more precautions (i.e.: wooden floors) since we use so little water to mop them.

7. We do hot mop the floor with dirty water. Only clean water with detergent is sprayed through the spray gun over the floor.

8. The easy cleaning and replacement of the sponge by the quick and simple take-off system, and thanks to its shape and texture, you can wash in the sink.

9. The important saving of water and cleaning product.

### DESCRIPTION OF THE INVENTION

The invention consists of a cleaning floor implement with cleaning liquid incorporated having a top spray gun. Different embodiments of this inventive concept are possible:

1. A rigid hollow transparent tube with a right angle section on its top end is the handle that contains water mixed with a cleaning liquid. The mixture is dispensed to the floor using a thin a precise jet, which comes out of a spray gun situated on the top end of the tube. The mop head is located on the bottom end of the tube and is attached in a fixed way. A sponge is attached to the head. The sponge is attached to the head by different systems:

The head has got small plastic pointed tips on its lower face and the sponge has got sticking fabric on its upper face.

The head is covered with Velcro (rough side) on its full lower face and the sponge is covered with Velcro (smooth side) on its full upper face

The sponge has a plastic plate stuck on its upper face, which joins the head thanks to two screws crossing the plate and two plastic butterfly nuts.

The sponge juts out of the head all around its perimeter so that the sling boards and furniture are not ruined when bumping into them. The sponge is cut with a 45° angle on its rear end to make the mopping under furniture and beds easy.

Said head can have different shapes:

It can be cylindrical and covered with a sponge with a detachable system, on the full or partial perimeter of said head.

It can have an equilateral triangle shape and two sponges with an equilateral triangle shape fit onto the head, each one at each side of the head. Sponges can be then took off, turned around and put back on the head, being used up to three times.

2. The head can be detachable:

Handle has a fixing system and head can be pulled off the handle.

Handle has a short extension, ending up with an outside thread, allowing any current spare parts such as mop heads, flat heads, floor-dryer heads or anything similar.

3. The head is articulated having a 360° rotation joint, allowing the mopping in narrow spaces.

4. Sponge can be replaced by disposable cloth made of non-woven fabric. In that case, head is provided with clutches or other means of fastening.

5 The floor-cleaning liquid is in a reservoir incorporated to the floor-cleaning implement. Said reservoir can have different shapes, sizes, be made of different materials and is located:

Inside the sponge

On the head

At any location on the handle

The handle can have an adhesive Velcro strip (rough side) to store spare sponges.

All the possibilities previously mentioned could have an ergonomic and anti-skid upper part on the top end with undulations, which adapt to both hands fingers.

### BRIEF DESCRIPTION OF THE DRAWINGS

FIG. 1 is a front view of one of the possible embodiment of the present invention.

FIG. 2 is a side view of FIG. 1.

FIG. 3 is a top view of FIG. 1

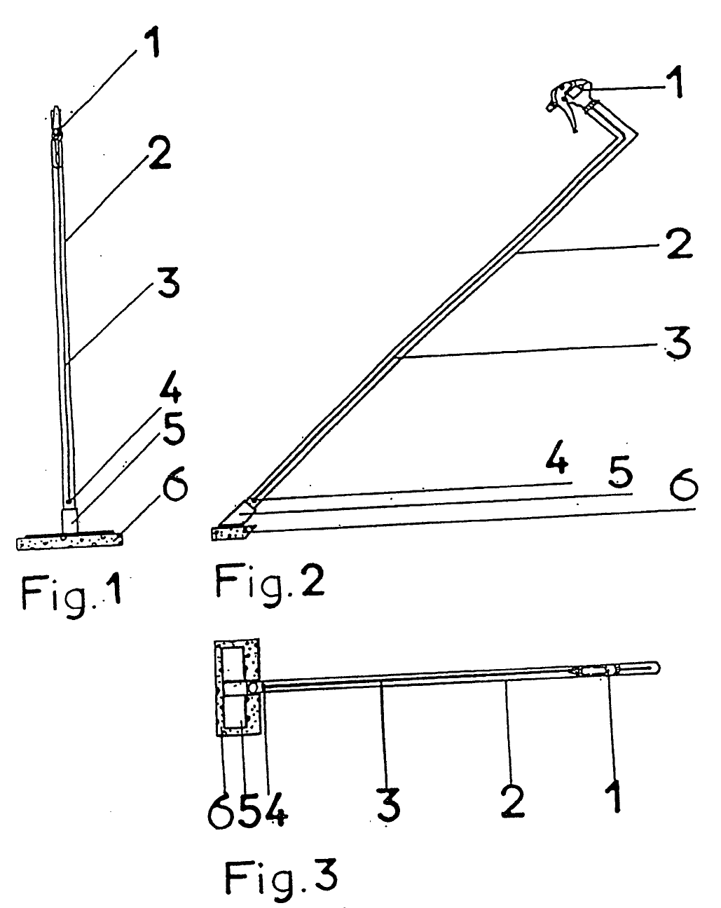

### DETAILED DESCRIPTION OF THE DRAWINGS

It consists of a rigid hollow transparent tube (2) with a constant diameter on all its length with a right angle section on its top end, ending with a spray gun (1) pointing to the floor and shooting a thin and precise jet. The handle (2) contains a flexible and transparent thin tube (3) that goes from the spray gun (1) to the bottom part of the handle. Said tube ends up with a small plastic filter (4). The task of the tube (3) consists in conveying water mixed with floor-cleaning product to the spray gun (1). The handle (2) is joined at its lower part to the head (5). A sponge (6) is stuck to the head (5) with a detachable system.

Mode for Carrying Out the Invention

The spray gun is unscrewed. The handle is filed with any cleaning-floor product and water. The spray gun is screwed back on. Liquid is shot 1 to 5 times and mopping is proceeded rubbing against the floor. The sponge is detached and washed in the sink. Once wringed out, said sponge is placed back and the implement is ready for a next use.

1. A floor cleaning implement with cleaning liquid incorporated having:
A top spray gun pointing to the floor and shooting a thin and precise jet
A flexible and transparent thin tube conveying liquid to the spray gun
A small plastic filter at the bottom end of said tube.
A rigid hollow transparent handle with a right handle section on its top end.

2. The cleaning implement of claim 1 having a head joined in a fixed way to said handle.

3. The cleaning implement of claim 2 having a detachable sponge on said head.

4. The cleaning implement of claim 3 having small plastic pointed tips on the lower face of said head and a sticking fabric on the upper face of said sponge as an attaching system.

5. The cleaning implement of claim 3 having said sponge covered with Velcro. (smooth side) on its upper face and said head covered with Velcro (rough side) on its lower face as an attaching system.

6. The cleaning implement of claim 3 having a plastic plate stuck on upper face of said sponge and 2 screws and plastic butterfly nuts. Said screws cross said plate as an attaching system.

7. The cleaning implement of claim 3, said head being cylindrical.

8. The cleaning implement of claim 3 having said head an equilateral triangle shape and two equilateral triangle shaped sponges to fit onto both sides of said head.

9. The cleaning implement of claim 1 having a detachable head. Said handle has a fixing system and said head can be pulled off said handle.

10. The cleaning implement of claim 1 allowing any current spare parts such as mop heads, flat heads, floor-dryer heads or anything similar. Said handle has a short extension, ending up with an outside thread.

11. The cleaning implement of claim 1 having a head at the bottom end of said handle. Said head is articulated having a 360° rotation joint.

12. The cleaning implement of claim 11 having a disposable cloth made of non woven fabric. In that case, head is provided with clutches or other means of fastening.

13. The cleaning implement of claim 1 having the floor-cleaning liquid in a reservoir incorporated to the floor-cleaning implement. Said reservoir can have different shapes, sizes, be made of different materials and is located:
Inside the sponge
On the head
At any location on the handle.

14. The cleaning implement of claim 1 having an adhesive Velcro strip (rough side) along said handle to store spare sponges.

15. The cleaning implement of claim 1 having an ergonomic and anti-skid upper part on the top end with undulations, which adapt to both hands fingers.
